(19) United States
(12) Patent Application Publication
(10) Pub. No.: US 2026/0324531 A1
(43) Pub. Date: Oct. 22, 2026

(54) AGRICULTURAL NAVIGATION METHODS, DEVICES, AND SYSTEMS

(71) Applicant: Ag Leader Technology, Ames, IA (US)

(72) Inventors: Trent Anagnostopoulos, Ankeny, IA (US); Josue Calderon, Apex, NC (US); Apurba Das, Ames, IA (US)

(21) Appl. No.: 19/468,722

(22) Filed: Feb. 3, 2026

Related U.S. Application Data
(60) Provisional application No. 63/753,258, filed on Feb. 3, 2025.

(51) Int. Cl. A01B 69/00; A01B 69/04; G05D 1/244; G05D 1/248; G05D 1/622; G05D 105/15; G05D 107/20; G05D 109/10; G05D 111/10; G06T 7/73

(52) U.S. Cl. CPC A01B 69/001; A01B 69/008; G05D 1/2446; G05D 1/248; G05D 1/622; G06T 7/73; G05D 2105/15; G05D 2107/21; G05D 2109/10; G05D 2111/10; G06T 2207/30204; G06T 2207/30252

(57) ABSTRACT

A system for navigating vehicles, such as agricultural vehicles, relative to one another. Various implementations are described where close navigation between vehicles is required, such as agricultural vehicles exchanging grain or other products. The systems employ a variety of devices and techniques to ensure close navigation is reliable and efficient, while avoiding collisions between vehicles.

### CROSS-REFERENCE TO RELATED APPLICATION(S)

This application claims priority to U.S. Provisional Application No. 63/753,258 filed Feb. 3, 2025, entitled “AGRICULTURAL NAVIGATION METHODS, DEVICES, AND SYSTEMS,” which is hereby incorporated by reference in its entirety under 35 U.S.C. § 119 (e).

### TECHNICAL FIELD

The disclosure relates to systems, methods, and devices for guidance, navigation, and positioning of agricultural vehicles.

### BRIEF SUMMARY

Disclosed herein are various implementations of a system for navigating vehicles, such as agricultural vehicles, relative to one another. In specific implementations, the system may guide harvesters near grain collection vehicles, such gravity wagons pulled by tractors or grain wagons pulled by semi-trucks. Various other implementations are similarly described where close navigation between vehicles is required. The system employs a variety of devices and techniques to ensure close navigation is reliable and efficient, while avoiding collisions between vehicles.

A system of one or more computers or computing devices can be configured to perform particular operations or actions by virtue of having software, firmware, hardware, or a combination of them installed on the system that in operation causes the system to perform the actions. One or more computer programs can be configured to perform particular operations or actions by virtue of including instructions that, when executed by data processing apparatus, cause the apparatus to perform the actions.

In Example 1, an agricultural guidance system comprises one or more visual fiducials on a first object; at least one camera mounted to a first vehicle, wherein the at least one camera views of the one or more visual fiducials and generates guidance and operations therefrom.

Example 2 relates to the agricultural guidance system of Examples 1 and 3-8, further comprising one or more sensors configured to improve the accuracy of guidance and operations.

Example 3 relates to the agricultural guidance system of Examples 1-2 and 4-8, wherein the one or more sensors are selected from the group consisting of LiDAR sensors, GPS sensors, radar, laser range finders, and ultrasonic sensors.

Example 4 relates to the agricultural guidance system of Examples 1-3 and 5-8, wherein the system generates guidance and operations by calculating a quality of fiducial view parameter associated with each fiducial of the one or more visual fiducials.

Example 5 relates to the agricultural guidance system of Examples 1~4 and 6-8, wherein the quality of fiducial view parameter is determined based on an angle between a center of a field of view of the at least one camera and the one or more visual fiducials and based on the pose of one or more visual fiducials relative to the at least one camera.

Example 6 relates to the agricultural guidance system of Examples 1-5 and 7-8, wherein some of the one or more visual fiducials are not used in the generation of guidance and operations if the corresponding quality of fiducial view parameter is negative.

Example 7 relates to the agricultural guidance system of Examples 1-6, wherein the first object is mobile.

Example 8 relates to the agricultural guidance system of Examples 1-6, wherein the first object is stationary.

In Example 9, an agricultural guidance system comprises one or more fiducials on a first object; a camera mounted to a driven vehicle, wherein the camera views the one or more fiducials and generates a path on which the driven vehicle may navigate.

Example 10 relates to the agricultural guidance system of Examples 11-16, the agricultural guidance system of claim 9, wherein the camera is configured to record images of a pose of the one or more fiducials, each image of the images taken at a recorded time.

Example 11 relates to the agricultural guidance system of Examples 10 and 12-16, further comprising a GPS sensor on the driven vehicle, the GPS configured determine location coordinates of the driven vehicle at the recorded time.

Example 12 relates to the agricultural guidance system of Examples 10-11 and 13-16, wherein the images taken at a recorded time and the location coordinates of the driven vehicle at the recorded time are combined to create a higher reference frame pose of the one or more fiducials.

Example 13 relates to the agricultural guidance system of Examples 10-12 and 14-16, wherein the higher reference frame pose of the one or more fiducials is used to ensure accuracy of the path.

Example 14 relates to the agricultural guidance system of Examples 10-13 and 15-16, wherein each of the one or more fiducials comprises a unique identifier.

Example 15 relates to the agricultural guidance system of Examples 10-14 and 16, wherein the path may be modified to avoid collisions between the driven vehicle and portions of the first object extending from a fiducial mounting area.

Example 16 relates to the agricultural guidance system of Examples 10-15, wherein the portions of the first object extending from a fiducial mounting area are identifiable by the unique identifier.

In Example 17, an agricultural guidance system comprises a visual fiducial on a first object; a camera mounted to a driven vehicle, wherein the camera views the one or more fiducials.

Example 18 relates to the agricultural guidance system of Examples 17 and 19-20, wherein the visual fiducial is mounted to the first object with a purposeful skew to allow for improved detection of changes in roll, pitch, and heading of the visual fiducial.

Example 19 relates to the agricultural guidance system of Examples 17-18 and 20, wherein the visual fiducial is mounted to the first object with a wedge to improve detection of the visual fiducial by the camera when the camera is near the first object.

Example 20 relates to the agricultural guidance system of Examples 17-19, comprising a second visual fiducial, wherein the visual fiducial is mounted to the first object with a skew in a first direction, and the second visual fiducial is mounted to the first object with a skew in a second direction, the second direction being approximately the opposite of the first direction.

While multiple implementations are disclosed, still other implementations of the disclosure will become apparent to those skilled in the art from the following detailed description, which shows and describes illustrative implementations of the invention. As will be realized, the disclosure is capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1A is a diagram of a target vehicle with visual fiducials attached, according to one implementation.

FIG. 1B is a close-up diagram of a target vehicle with visual fiducials attached, according to one implementation.

FIG. 2 is a diagram of a target vehicle showing a vertical installation error of a fiducial, according to one implementation.

FIG. 3 is a diagram of a target vehicle showing a roll installation error of a fiducial, according to one implementation.

FIG. 4 is a diagram of a target vehicle with a coordinate system described by attached fiducials, according to one implementation.

FIG. 5 is a diagram of a target vehicle and driven vehicle with an offset area, according to one implementation.

FIG. 6 is a diagram of a target vehicle and driven vehicle with a violated offset area, according to one implementation.

FIG. 7 is a diagram of a target vehicle within the LiDAR zone of interest of a driven vehicle, according to one implementation.

FIG. 8 is a diagram of a driven vehicle near a target vehicle, but with another target vehicle in the generated path, according to one implementation.

FIG. 9 is a diagram of quality of view estimates between a camera and fiducials, according to one implementation.

FIG. 10 illustrates a fiducial mounted to a target vehicle in a skewed position, according to one implementation.

FIG. 11 illustrates a fiducial mounted to a target vehicle with a wedge, according to one implementation.

FIG. 12 illustrates two fiducials mounted to a target vehicle in positions skewed opposite of one another, according to one implementation.

FIG. 13 shows a driven vehicle near a target vehicle with opposite heading, according to one implementation.

FIG. 14 shows a driven vehicle and a target vehicle with opposite heading and enough distance to cease automatic navigation, according to one implementation.

FIG. 15 shows a driven vehicle and a target vehicle with different enough heading to cease automatic navigation, according to one implementation.

FIG. 16 shows a driven vehicle near a target vehicle with a predetermined offset, according to one implementation.

### DETAILED DESCRIPTION

Disclosed herein are various systems for aligning vehicles, such as agricultural vehicles, while accounting for installation errors and inconsistencies when using visual fiducials for localization and guidance, along with associated methods and devices.

Certain of the disclosed implementations can be used in conjunction with any of the devices, systems or methods taught or otherwise disclosed in U.S. Pat. No. 10,684,305 issued Jun. 16, 2020, entitled “Apparatus, Systems and Methods for Cross Track Error Calculation From Active Sensors,” U.S. patent application Ser. No. 16/121,065, filed Sep. 4, 2018, entitled “Planter Down Pressure and Uplift Devices, Systems, and Associated Methods,” U.S. Pat. No. 10,743,460, issued Aug. 18, 2020, entitled “Controlled Air Pulse Metering apparatus for an Agricultural Planter and Related Systems and Methods,” U.S. Pat. No. 11,277,961, issued Mar. 22, 2022, entitled “Seed Spacing Device for an Agricultural Planter and Related Systems and Methods,” U.S. patent application Ser. No. 16/142,522, filed Sep. 26, 2018, entitled “Planter Downforce and Uplift Monitoring and Control Feedback Devices, Systems and Associated Methods,” U.S. Pat. No. 11,064,653, issued Jul. 20, 2021, entitled “Agricultural Systems Having Stalk Sensors and/or Data Visualization Systems and Related Devices and Methods,” U.S. Pat. No. 11,297,768, issued Apr. 12, 2022, entitled “Vision Based Stalk Sensors and Associated Systems and Methods,” U.S. patent application Ser. No. 17/013,037, filed Sep. 4, 2020, entitled “Apparatus, Systems and Methods for Stalk Sensing,” U.S. patent application Ser. No. 17/226,002 filed Apr. 8, 2021, and entitled “Apparatus, Systems and Methods for Stalk Sensing,” U.S. Pat. No. 10,813,281, issued Oct. 27, 2020, entitled “Apparatus, Systems, and Methods for Applying Fluid,” U.S. patent application Ser. No. 16/371,815, filed Apr. 1, 2019, entitled “Devices, Systems, and Methods for Seed Trench Protection,” U.S. patent application Ser. No. 16/523,343, filed Jul. 26, 2019, entitled “Closing Wheel Downforce Adjustment Devices, Systems, and Methods,” U.S. patent application Ser. No. 16/670,692, filed Oct. 31, 2019, entitled “Soil Sensing Control Devices, Systems, and Associated Methods,” U.S. patent application Ser. No. 16/684,877, filed Nov. 15, 2019, entitled “On-The-Go Organic Matter Sensor and Associated Systems and Methods,” U.S. Pat. No. 11,523,554, issued Dec. 13, 2022, entitled “Dual Seed Meter and Related Systems and Methods,” U.S. patent application Ser. No. 16/891,812, filed Jun. 3, 2020, entitled “Apparatus, Systems and Methods for Row Cleaner Depth Adjustment On-The-Go,” U.S. Pat. No. 11,678,607, issued Jun. 20, 2023, entitled “Apparatus, Systems, and Methods for Eliminating Cross-Track Error,” U.S. patent application Ser. No. 16/921,828, filed Jul. 6, 2020, entitled “Apparatus, Systems and Methods for Automatic Steering Guidance and Visualization of Guidance Paths,” U.S. Pat. No. 12,353,210, issued Jul. 8, 2025, entitled “Apparatus, Systems and Methods for Automated Navigation of Agricultural Equipment,” U.S. patent application Ser. No. 16/997,361, filed Aug. 19, 2020, entitled “Apparatus, Systems and Methods for Steerable Toolbars,” U.S. Pat. No. 11,785,881, issued Oct. 17, 2023, entitled “Adjustable Seed Meter and Related Systems and Methods,” U.S. patent application Ser. No. 17/011,737, filed Sep. 3, 2020, entitled “Planter Row Unit and Associated Systems and Methods,” U.S. Pat. No. 11,877,530 issued Jan. 23, 2024, entitled “Agricultural Vacuum and Electrical Generator Devices, Systems, and Methods,” U.S. patent application Ser. No. 17/105,437, filed Nov. 25, 2020, entitled “Devices, Systems and Methods For Seed Trench Monitoring and Closing,” U.S. patent application Ser. No. 17/127,812, filed Dec. 18, 2020, entitled “Seed Meter Controller and Associated Devices, Systems and Methods,” U.S. patent application Ser. No. 17/132,152, filed Dec. 23, 2020, entitled “Use of Aerial Imagery For Vehicle Path Guidance and Associated Devices, Systems, and Methods,” U.S. patent application Ser. No. 17/164,213, filed Feb. 1, 2021, entitled “Row Unit Arm Sensor and Associated Systems and Methods,” U.S. Pat. No. 12,268,115, issued Apr. 8, 2025, entitled “Planter Obstruction Monitoring and Associated Devices and Methods,” U.S. patent application Ser. No. 17/225,586, filed Apr. 8, 2021, entitled “Devices, Systems, and Methods for Corn Headers,” U.S. Pat. No. 11,758,848, issued Sep. 19, 2023, entitled “Devices, Systems, and Methods for Sensing the Cross Sectional Area of Stalks,” U.S. patent application Ser. No. 17/323,649, filed May 18, 2021, entitled “Assisted Steering Apparatus and Associated Systems and Methods,” U.S. patent application Ser. No. 17/369,876, filed Jul. 7, 2021, entitled “Apparatus, Systems, and Methods for Grain Cart-Grain Truck Alignment and Control Using GNSS and/or Distance Sensors,” U.S. patent application Ser. No. 17/381,900, filed Jul. 21, 2021, entitled “Visual Boundary Segmentations and Obstacle Mapping for Agricultural Vehicles,” U.S. patent application Ser. No. 17/461,839, filed Aug. 30, 2021, entitled “Automated Agricultural Implement Orientation Adjustment System and Related Devices and Methods,” U.S. Pat. No. 12,414,505, issued Sep. 16, 2025, entitled “Apparatus, Systems, and Methods for Row-by-Row Control of a Harvester,” U.S. patent application Ser. No. 17/526,947, filed Nov. 15, 2021, entitled “Agricultural High Speed Row Unit,” U.S. patent application Ser. No. 17/556,506, filed Dec. 20, 2021, entitled “Devices, Systems, and Method For Seed Delivery Control,” U.S. patent application Ser. No. 17/576,463, filed Jan. 14, 2022, entitled “Apparatus, Systems, and Methods for Row Crop Headers,” U.S. Pat. No. 12,403,950, issued Sep. 2, 2025, entitled “Automatic Steering Systems and Methods,” U.S. patent application Ser. No. 17/742,373, filed May 11, 2022, entitled “Calibration Adjustment for Automatic Steering Systems,” U.S. patent application Ser. No. 17/902,366, filed Sep. 2, 2022, entitled “Tile Installation System with Force Sensor and Related Devices and Methods,” U.S. patent application Ser. No. 17/939,779, filed Sep. 7, 2022, entitled “Row-by-Row Estimation System and Related Devices and Methods,” U.S. patent application Ser. No. 18/215,721, filed Jun. 28, 2023, entitled “Seed Tube Guard and Associated Systems and Methods of Use,” U.S. patent application Ser. No. 18/087,413, filed Dec. 22, 2022, entitled “Data Visualization and Analysis for Harvest Stand Counter and Related Systems and Methods,” U.S. patent application Ser. No. 18/097,804, filed Jan. 17, 2023, entitled “Agricultural Mapping and Related Systems and Methods,” U.S. patent application Ser. No. 18/101,394, filed Jan. 25, 2023, entitled “Seed Meter with Integral Mounting Method for Row Crop Planter and Associated Systems and Methods,” U.S. patent application Ser. No. 18/102,022, filed Jan. 26, 2023, entitled “Load Cell Backing Plate and Associated Devices, Systems, and Methods,” U.S. patent application Ser. No. 18/116,714, filed Mar. 2, 2023, entitled “Cross Track Error Sensor and Related Devices, Systems, and Methods,” U.S. patent application Ser. No. 18/203,206, filed May 30, 2023, entitled “Seed Tube Camera and Related Devices, Systems and Methods,” U.S. patent application Ser. No. 18/209,331, filed Jun. 13, 2023, entitled “Apparatus, Systems and Methods for Image Plant Counting,” U.S. patent application Ser. No. 18/217,216, filed Jun. 30, 2023, entitled “Combine Unloading On-The-Go with Bin Level Sharing and Associated Devices, Systems, and Methods,” U.S. patent application Ser. No. 18/229,974, filed Aug. 3, 2023, entitled “Hydraulic Cylinder Position Control for Lifting and Lowering Towed Implements,” U.S. patent application Ser. No. 18/230,534, filed Aug. 4, 2023, entitled “Single-Step Seed Placement in Furrow and Related Devices, Systems, and Methods,” U.S. patent application Ser. No. 18/238,344, filed Aug. 25, 2023, entitled “Combine Yield Monitor Automatic Calibration System and Associated Devices and Methods,” U.S. patent application Ser. No. 18/367,929, filed Sep. 13, 2023, entitled “Hopper Lid with Magnet Retention and Related Systems and Methods,” U.S. patent application Ser. No. 18/516,514, filed Nov. 21, 2023, entitled “Stalk Sensors and Related Devices, Systems, and Methods,” U.S. patent application Ser. No. 18/441,708, filed Feb. 14, 2024, entitled “Liquid Flow Meter and Flow Balancer and Associated Devices, Systems, and Methods,” U.S. patent application Ser. No. 18/662,800, filed May 13, 2024, entitled “Devices, Systems, and Methods for Providing Yield Maps,” U.S. patent application Ser. No. 18/665,305, filed May 15, 2024, entitled “Devices, Systems, and Methods for Agricultural Guidance and Navigation,” U.S. patent application Ser. No. 18/761,041, filed Jul. 1, 2024, entitled “Ring Assembly For Automatic and/or Assisted Steering and Associated Systems and Methods,” U.S. patent application Ser. No. 18/766,374, filed Jul. 8, 2024, entitled “Assisted Steering Systems and Associated Devices and Methods for Agricultural Vehicles,” U.S. patent application Ser. No. 18/929,309, filed Oct. 28, 2024, entitled “Agricultural Implement Position Sensor and Related Devices, Systems, and Methods,” U.S. patent application Ser. No. 18/962,799, filed Nov. 27, 2024, entitled “Devices, Systems and Methods for Guidance Line Shifting,” U.S. patent application Ser. No. 18/974,482, filed Dec. 9, 2024, entitled “Header Height Control Devices, Systems and Methods,” U.S. patent application Ser. No. 18/980,728, filed Dec. 13, 2024, entitled “Deck Plate Spacing Sensors and Related Devices, Systems, and Methods,” U.S. patent application Ser. No. 19/041,787, filed Jan. 30, 2025, entitled “Grain Cart Unloading Sensor and Unload Control System and Associated Devices and Methods,” U.S. patent application Ser. No. 19/207,115, filed May 13, 2025, entitled “Devices, Systems, and Methods for Planter and Seed Trench Imaging and Analysis,” U.S. patent application Ser. No. 19/219,718, fled May 27, 2025, entitled “Devices, Systems, and Methods for Agricultural Navigation and Positioning,” U.S. patent application Ser. No. 19/226,004, filed Jun. 2, 2025, entitled “Devices, Systems, and Methods for Machinery Monitoring and Reporting,” U.S. Patent Application 63/667,546, filed Jul. 3, 2024, entitled “Cover for Port Openings,” U.S. patent application Ser. No. 19/260,159, filed Jul. 3, 2025, entitled “Agricultural Seed Meters and Related Devices, Systems and Methods,” U.S. patent application Ser. No. 19/297,963, filed Aug. 12, 2025, entitled “Agricultural Navigation and Steering Systems, Devices and Methods,” U.S. patent application Ser. No. 19/305,530, filed Aug. 20, 2025, entitled “Crop Sensor Wands and Related Devices, Systems, and Methods,” U.S. patent application Ser. No. 19/366,202, filed Oct. 22, 2025, entitled “Crop Sensors and Related Devices, Systems, and Methods,” U.S. patent application Ser. No. 19/367,363, filed Oct. 23, 2025, entitled “Agricultural Sprayer Sensor and Related Devices, Systems, and Methods,” U.S. patent application Ser. No. 19/390,280, filed Nov. 14, 2025, entitled “Liquid Product Distribution for Agricultural Spraying Systems and Related Devices and Methods,” U.S. patent application Ser. No. 19/396,047, filed Nov. 20, 2025, entitled “Agricultural Harvesting Systems and Related Devices and Methods,” U.S. patent application Ser. No. 19/396,099, filed Nov. 20, 2025, entitled “Sprayer Nozzle Devices and Related Systems and Methods,” U.S. patent application Ser. No. 19/397,422, filed Nov. 21, 2025, entitled “Systems, Methods, and Devices for Increasing Machine Operating Range,” U.S. patent application Ser. No. 19/408,177, filed Dec. 3, 2025, entitled “Agricultural Guidance and Navigation System and Related Devices and Methods,” U.S. patent application Ser. No. 19/467,539, filed Jan. 31, 2025, entitled “System and Automatic Adjustment to Target Pressure and Related Devices and Methods,” U.S. patent application Ser. No. 19/467,588, filed Feb. 2, 2026, entitled “Harvester Liquid Application System, Devices, and Methods,” U.S. Patent Application 63/753,201, filed Feb. 3, 2025, entitled “Agricultural Mapping and Related Devices, Systems, and Methods” U.S. Patent Application 63/755,675, filed Feb. 7, 2025, entitled “Remote Assistance for Agricultural Display Methods and Related Devices and Systems,” U.S. Patent Application 63/757,242, filed Feb. 11, 2025, entitled “Seed Meter,” U.S. Patent Application 63/757,434, filed Feb. 12, 2025, entitled “Grain Fill Sensor,” U.S. Patent Application 63/760,907, filed Feb. 20, 2025, entitled Agricultural Yield Monitoring and Estimation Devices, Systems, and Methods,” U.S. Patent Application 63/816,284, filed Jun. 2, 2025, entitled “Agricultural Guidance and Navigation Systems, Methods, and Devices,” U.S. Patent Application 63/817,692, filed Jun. 4, 2025, entitled “Intelligent Steering System for Sprayers and Tractors in Standing Crops,” U.S. Patent Application 63/818,248, filed Jun. 5, 2025, entitled “Devices, Systems, and Methods for Determining Implement Pose,” U.S. Patent Application 63/906,692, filed Oct. 28, 2025, entitled “Agricultural Alignment System and Related Devices and Methods,” U.S. Patent Application 63/906,646, filed Oct. 28, 2025, entitled “Automated Grail Filling System and Related Devices and Methods,” U.S. Patent Application 63/967,084, filed Jan. 23, 2025, entitled “System and Methods of Row-by-Row Yield Monitoring,” U.S. Patent Application 63/966,976, filed Jan. 23, 2025, entitled “Dispatch Indicator Calibration,” and U.S. Patent Application 63/967,038, filed Jan. 23, 2025, entitled “Grain Fill Sensor and Related Devices, Systems, and Methods,” each of which is incorporated herein by reference.

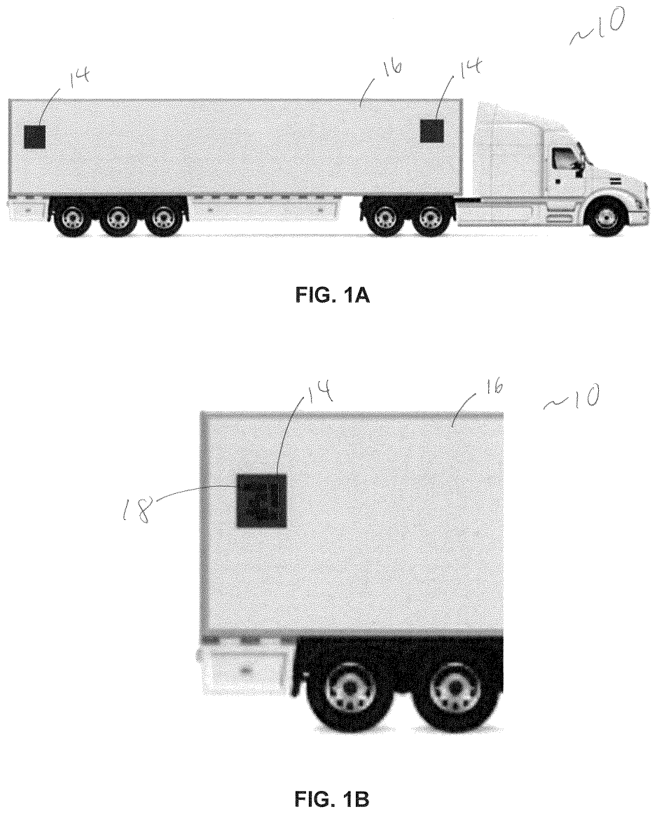

Turning to FIG. 1A, the system 10 for aligning driven vehicles 12, optionally with cameras or sensors, with other objects 16 or target vehicles 16 while accounting for inconsistencies, may use one or more fiducials 14 placed on the objects 16 or vehicles 16. As would be understood, the driven vehicles 12 and objects 16 or target vehicles 16 may be any relevant tool, implement, storage device, transportation device, or the like that may shift in position to its surroundings, and thus require alignment. In certain implementations, one driven vehicle 12 may be a tractor and gravity wagon combination while the target vehicle 16 may be a tractor and semi-trailer combination. In such implementations, it may be necessary to quickly and efficiently align the gravity wagon and semi-trailer to allow for the efficient transfer of harvested material from the gravity wagon to the semi-trailer. In other implementations, other combinations of driven vehicles 12 and target vehicles 16 may be used, such as but not limited to a harvester and gravity wagon or other pairings or combinations that may be necessary. In some implementations, the system 10 may align one driven vehicle 12 with a stationary object 16, such as a storage building. In these implementations, it is understood that the various aspects of the system 10 that would be applied to a driven vehicle 12 may instead be applied to an object, such as a building or fixture.

The system 10 may be used in variety of ways, an exemplary, non-exhaustive description of which is given below.

One exemplary use of the system 10 may be for guidance of a driven vehicle 12 constructed to supply product to a grain trailer 16 configured to receive product. In various implementations, visual fiducials 14 may be placed on a grain trailer 16 hauled by a semi truck. The system 10 may improve the pose estimate of that grain trailer 16 for the purpose of unloading into the trailer 16 from a grain cart 12 or combine 12. For the purposes of this disclosure, the pose of a target vehicle 16 may refer to the location and orientation of the target vehicle 16 relative to the driven vehicle 12 and relative to other objects in the surrounding environment. In various implementations, the pose of a target vehicle 16 may incorporate its orientation relative to the cardinal directions.

Another exemplary use of the system 10 may be for guidance of a driven vehicle 12 configured to receive product to a target vehicle 16 configured to supply product. The system 10 may improve the estimate of the pose of a target vehicle 16 for the purpose of guiding to or alongside it. For example, a grain cart 12 driving alongside a combine 16 to unload grain from the combine 16 into the grain cart 12.

Another exemplary use of the system 10 may be for loading or unloading goods. Loading or unloading goods often requires precise driving to a known location. That location can be marked with visual fiducials 14 for guidance. The system 10 may improve the estimate of that location, allowing for more precise driving and positioning of a vehicle 12 relative to that location.

Another exemplary use of the system 10 may be for geo-referencing. Visual fiducials 14 with a high-quality pose estimate may be used for geo-referencing. For example, GPS drift errors may be corrected upon seeing the fiducial 14.

The system 10 may require calibration for reliable operation. Below is a description of the system 10 and the calibration techniques that may ensure reliable operation.

The calibration of the system 10 may also identify objects 16 and target vehicles 16 as an aspect of calibration and general operation of the system 10, which is described below.

In the system 10, it may be useful to not only identify fiducials 14 and their pose but also to identify what each fiducial 14 represents. As would be understood, the pose of a fiducial 14 may refer to the location and orientation of the fiducial 14 relative to the vehicle 16 onto which it is applied. Various implementations of this method may combine identification of the fiducial 14 and its pose along with unique identification of the specific fiducial 14, optionally accomplished using a unique identifier 18, which may be part of the fiducial 14. This may be accomplished through various means, such as but not limited to different colors, color combinations, different unique shapes, bar codes, QR codes, or any method that may allow a camera to uniquely identify one fiducial 14 from another. As shown in FIG. 1B, the unique identifier 18, in the form of a distinctive pattern of dark squares, can be seen on the fiducial 14.

In various implementations, the unique identifiers 18 may be split into subsections to identify the type of object 16 onto which they are attached or which of a number of the same object 16 the fiducial 14 is attached. For example, a grain trailer 16 may require multiple fiducials 14 to allow a grain cart 12 to guide to it and unload. The unique identifier 18 of this fiducial 14 may be chosen such that its position on the trailer 16 is known. It may also be chosen so that it is known exactly which grain trailer 16 is being viewed if the farmer owns or operates multiple.

One possible split of unique identifiers 18 if the object requires nine or fewer fiducials 14 is to number the fiducials 0-X (where X is limited only by the method of identification). Fiducials 14 numbered 0-9 can be assumed to be on the first object, fiducials 14 numbered 11-19 can be assumed to be on the second object, and so forth.

In other implementations, it is possible to assign unique identifier 18 numbers to types of things. For example, fiducial 14 one for grain trailers 16, fiducial 14 two for combines 16, fiducial 14 three for grain silos, etc.

Various implementations of the system 10 may cover any split or packing structure that is used to make assumptions about the type of object or the instance of the object 16 bearing the fiducial 14.

In some implementations, this identification may be used as a lookup for the appropriate calibrate for each fiducial 14. As the physical installation of fiducials 14 may not be perfect, each individual fiducial may have different errors and represent different desired guidance behavior. The appropriate per-fiducial calibrations may be saved in the system 10 and applied appropriately as the fiducial 14 is identified.

Various implementations of the system 10 may automatically calibrate using visual fiducials 14, as described below.

In various implementations, physical installation of fiducials 14 may be prone to errors. The user of the system 10, optionally a farmer, is unlikely to have the equipment or time to manually measure distances and angles of the fiducials with high precision. To compensate for this, the system 10 may be able to detect, estimate, and account for installation errors. FIGS. 2 and 3 show various exemplary installation errors. FIG. 2 illustrates a potential instance of a vertical installation error, where the fiducial 14 may not be installed at the proper location, but may instead be installed in a location vertically translated from the proper location, indicated by the hollow box below the shown fiducial 14. FIG. 3 illustrates a potential instance of a rotational installation error, where the fiducial 14 may be rotated about its center relative to its proper orientation.

In various implementations, it may be necessary for the physical relationship between the fiducial 14 and the parent object 16 to be known. In some implementations, it may be necessary that the user of the system 10 enter this information, but in other implementations, the information may be pre-programmed into the camera's processor. For example, a grain trailer 16 may need a fiducial 14 on the front, two on each side and one on the back. The inward offset from the side of the trailer for the front and back tags and the distance along the side of the trailer between the side mounted tags may be predetermined. In this example, the angle differences may be assumed to be about 0 degrees for the side fiducials 14 and about 90 degrees for the front and back fiducials 14.

The system 10 may require at least three fiducials 14 if all the fiducials 14 are installed on some shared plane and may require at least four if they are not all planar. In some implementations, if all the fiducials 14 are installed at the same height it may be sufficient to use three fiducials 14. If the fiducials 14 are all installed on the side of the target vehicle 16 but different heights, it may be sufficient to use three fiducials 14. If the fiducials 14 are at different heights and at least one is on the front of the target vehicle 16, four or more fiducials 14 may be required. In some implementations, it may be necessary to see each fiducial 14 at some point in the calibration process to calibrate its particular errors.

The calibration method 100 may begin with the driven vehicle 12, which may be bearing a camera (shown in figures discussed below), establishing a known path (22, show in later figures) relative to the fiducials 14, which when traversed, will allow the camera to see each fiducial 14. In various implementations, the path 22 may either not allow roll, pitch and heading changes for the driven vehicle 12, or the system 10 may know the roll, pitch, and heading the driven vehicle 12 bearing the camera with high accuracy, to ensure accuracy of the calibration. The driven vehicle 12 may remain stationary to ensure accuracy, if all fiducials 14 are visible from a single position.

Model dynamics of the path 22 or vehicle 12 may be fed into the system 10 to make predictions about where the fiducials 14 should be and how they should change over the course of the path 22. The combination of the expected installation relationships between the fiducials 14 and the model dynamics of the vehicle 12 may be used to estimate the installation error of the fiducials 14 in terms of X, Y, Z, roll (φ), pitch (θ) and yaw (ψ) biases. A confounding factor may be inaccuracy in the fiducial 14 pose estimation. Resolving inaccuracy in the fiducial 14 pose estimate may require special attention to detect the constant installation errors and filter out the temporary pose estimation errors. A state estimator may be used in the system 10 to allow for simultaneous filtering of noisy values while estimating the proposed biases.

In various implementations, the state estimator may use a Kalman filter. In the following example Kalman filter, the dynamics of the vehicle 12 are used to project each fiducial 14 into a higher reference frame, which are GPS coordinates in this example, but may be various other reference frames. The fiducial 14 GPS pose estimates are fed into a Kalman filter which combines the known noise levels of pose estimation with expected distance and angle relationships between the fiducials 14 to estimate the installation errors.

For example, with a grain trailer and tractor 12 bearing a camera on flat ground. In this example, the grain trailer 12 may have three fiducials 14 installed, one on the front and two on the sides. The expected poses of each fiducial 14, one through three, may be as follows.

$${F}_{E 1} = {[ {X}_{E 1} , {Y}_{E 1} , {Z}_{E 1} , {ϕ}_{E 1} , {θ}_{E 1} , {ψ}_{E 1} ]}^{T} = {[ - 0.50 , 0. , 2. , 0 , 0 , 90 ]}^{T} \qquad ( 1 )$$

$${F}_{E 2} = {[ {X}_{E 2} , {Y}_{E 2} , {Z}_{E 2} , {ϕ}_{E 2} , {θ}_{E 2} , {ψ}_{E 2} ]}^{T} = {[ 0. , 3. , 2. , 0 , 0 , 0 ]}^{T}$$

$${F}_{E 3} = {[ {X}_{E 3} , {Y}_{E 3} , {Z}_{E 3} , {ϕ}_{E 3} , {θ}_{E 3} , {ψ}_{E 3} ]}^{T} = {[ 0. , 6. , 2. , 0 , 0 , 0 ]}^{T}$$

In this example, which is illustrated in FIG. 4, (0, 0, 0) is the bottom corner of the grain trailer 12 and is shared between the front and the side of the trailer 12 with fiducials 14. Zero degrees heading may be defined as parallel down the long side of the trailer 12 and perpendicular to the front, although other default orientations may be used. The chosen path 22 in this example may be a straight line offset from, and parallel to, the trailer 12 with no roll or pitch changes. The algorithm chosen for this example is the extended Kalman Filter, although others may be used.

As the path 22 is driven, each image may processed to find the pose of the fiducial 14 and project the camera space pose into a higher reference frame pose. This process may require information about the mounting of the camera and the offsets of the camera relative to the tractor 12. Each image which contains enough information to estimate the pose of one or more fiducials may be processed through the Kalman filter or other state estimator. The particular equations of the state estimator may be adjusted based on various situational factors, such as but not limited to which fiducials are in view.

The estimated states of fiducials 14 not in view of the camera may not be processed in the normal innovation step.

The following equations show an example the appropriate relationship of fiducial 14 poses to one another in camera space based on their expected install locations.

$${X}_{13} = {X}_{E 3} - {X}_{E 1} \qquad ( 2 )$$

$${Y}_{13} = {Y}_{E 3} - {Y}_{E 1}$$

$${Z}_{13} = {Z}_{E 3} - {Z}_{E 1}$$

$${ϕ}_{1 {3}^{=}} {ϕ}_{E 3} - {ϕ}_{E 1}$$

$${θ}_{13} = {θ}_{E 3} - {θ}_{E 1}$$

$${ψ}_{13} = {ψ}_{E 3} - {ψ}_{E 1}$$

$${X}_{12} = {X}_{E 2} - {X}_{E 1}$$

$${Y}_{12} = {Y}_{E 2} - {Y}_{E 1}$$

$${Z}_{12} = {Z}_{E 2} - {Z}_{E 1}$$

$${ϕ}_{1 {2}^{=}} {ϕ}_{E 2} - {ϕ}_{E 1}$$

$${θ}_{12} = {θ}_{E 2} - {θ}_{E 1}$$

$${ψ}_{12} = {ψ}_{E 2} - {ψ}_{E 1}$$

$${X}_{23} = {X}_{E 3} - {X}_{E 2}$$

$${Y}_{23} = {Y}_{E 3} - {Y}_{E 2}$$

$${Z}_{23} = {Z}_{E 3} - {Z}_{E 2}$$

$${ϕ}_{2 {3}^{=}} {ϕ}_{E 3} - {ϕ}_{E 2}$$

$${θ}_{23} = {θ}_{E 3} - {θ}_{E 2}$$

$${ψ}_{23} = {ψ}_{E 3} - {ψ}_{E 2}$$

$${X}_{21} = {X}_{E 1} - {X}_{E 2}$$

$${Y}_{21} = {Y}_{E 1} - {Y}_{E 2}$$

$${Z}_{21} = {Z}_{E 1} - {Z}_{E 2}$$

$${ϕ}_{21} = {ϕ}_{E 1} - {ϕ}_{E 2}$$

$${θ}_{21} = {θ}_{E 1} - {θ}_{E 2}$$

$${ψ}_{21} = {ψ}_{E 1} - {ψ}_{E 2}$$

$${X}_{32} = {X}_{E 2} - {X}_{E 3}$$

$${Y}_{32} = {Y}_{E 2} - {Y}_{E 3}$$

$${Z}_{32} = {Z}_{E 2} - {Z}_{E 3}$$

$${ϕ}_{32} = {ϕ}_{E 2} - {ϕ}_{E 3}$$

$${θ}_{32} = {θ}_{E 2} - {θ}_{E 3}$$

$${ψ}_{32} = {ψ}_{E 2} - {ψ}_{E 3}$$

The state estimator and Kalman filter may be used to estimate the biases, otherwise known as installation errors, of the poses of the fiducials 14 by comparing the camera relative poses to the expected installation pose relationships between the fiducials 14. Once sufficient data has been completed, the biases estimated by the state estimator and Kalman filter may represent the installation errors for each fiducial 14. The below equations show an example of the dynamics for one possible Kalman filter.

$${X}_{bias 1} = \frac{1}{2} ⌋ [ {X}_{3} + {X}_{bias 3} ] - [ {X}_{1} + {X}_{bias 1} ] - {X}_{13} ⌊ + ⌋ [ {X}_{2} + {X}_{bias 2} ] - [ {X}_{1} + {X}_{bias 1} ] - {X}_{12} ⌊ \qquad ( 3 )$$

$${Y}_{bias 1} = \frac{1}{2} ⌋ [ {Y}_{3} + {Y}_{bias 3} ] - [ {Y}_{1} + {Y}_{bias 1} ] - {Y}_{13} ⌊ + ⌋ [ {Y}_{2} + {Y}_{bias 2} ] - [ {Y}_{1} + {Y}_{bias 1} ] - {Y}_{12} ⌊$$

$${Z}_{bias 1} = \frac{1}{2} ⌋ [ {Z}_{3} + {Z}_{bias 3} ] - [ {Z}_{1} + {Z}_{bias 1} ] - {Z}_{13} ⌊ + ⌋ [ {Z}_{2} + {X}_{bias 2} ] - [ {Z}_{1} + {X}_{bias 1} ] - {Z}_{12} ⌊$$

$${ϕ}_{bias 1} = \frac{1}{2} ⌋ [ {ϕ}_{3} + {ϕ}_{bias 3} ] - [ {ϕ}_{1} + {ϕ}_{bias 1} ] - {ϕ}_{13} ⌊ + ⌋ [ {ϕ}_{2} + {ϕ}_{bias 2} ] - [ {ϕ}_{1} + {ϕ}_{bias 1} ] - {ϕ}_{12} ⌊$$

$${θ}_{bias 1} = \frac{1}{2} ⌋ [ {θ}_{3} + {θ}_{bias 3} ] - [ {θ}_{1} + {θ}_{bias 1} ] - {θ}_{13} ⌊ + ⌋ [ {θ}_{2} + {θ}_{bias 2} ] - [ {θ}_{1} + {θ}_{bias 1} ] - {θ}_{12} ⌊$$

$${ψ}_{bias 1} = \frac{1}{2} ⌋ [ {ψ}_{3} + {ψ}_{bias 3} ] - [ {ψ}_{1} + {ψ}_{bias 1} ] - {ψ}_{13} ⌊ + ⌋ [ {ψ}_{2} + {ψ}_{bias 2} ] - [ {ψ}_{1} + {ψ}_{bias 1} ] - {ψ}_{12} ⌊$$

$${X}_{bias 2} = \frac{1}{2} ⌋ [ {X}_{3} + {X}_{bias 3} ] - [ {X}_{2} + {X}_{bias 2} ] - {X}_{23} ⌊ + ⌋ [ {X}_{1} + {X}_{bias 1} ] - [ {X}_{2} + {X}_{bias 2} ] - {X}_{21} ⌊$$

$${Y}_{bias 2} = \frac{1}{2} ⌋ [ {Y}_{3} + {Y}_{bias 3} ] - [ {Y}_{2} + {Y}_{bias 2} ] - {Y}_{23} ⌊ + ⌋ [ {Y}_{1} + {Y}_{bias 1} ] - [ {Y}_{2} + {Y}_{bias 2} ] - {Y}_{21} ⌊$$

$${Z}_{bias 2} = \frac{1}{2} ⌋ [ {Z}_{3} + {Z}_{bias 3} ] - [ {Z}_{2} + {Z}_{bias 2} ] - {Z}_{23} ⌊ + ⌋ [ {Z}_{1} + {X}_{bias 1} ] - [ {Z}_{2} + {X}_{bias 2} ] - {Z}_{21} ⌊$$

$${ϕ}_{bias 2} = \frac{1}{2} ⌋ [ {ϕ}_{3} + {ϕ}_{bias 3} ] - [ {ϕ}_{2} + {ϕ}_{bias 2} ] - {ϕ}_{23} ⌊ + ⌋ [ {ϕ}_{1} + {ϕ}_{bias 1} ] - [ {ϕ}_{2} + {ϕ}_{bias 2} ] - {ϕ}_{21} ⌊$$

$${θ}_{bias 2} = \frac{1}{2} ⌋ [ {θ}_{3} + {θ}_{bias 3} ] - [ {θ}_{2} + {θ}_{bias 2} ] - {θ}_{23} ⌊ + ⌋ [ {θ}_{1} + {θ}_{bias 1} ] - [ {θ}_{2} + {θ}_{bias 2} ] - {θ}_{21} ⌊$$

$${ψ}_{bias 2} = \frac{1}{2} ⌋ [ {ψ}_{3} + {ψ}_{bias 3} ] - [ {ψ}_{2} + {ψ}_{bias 2} ] - {ψ}_{23} ⌊ + ⌋ [ {ψ}_{1} + {ψ}_{bias 1} ] - [ {ψ}_{2} + {ψ}_{bias 2} ] - {ψ}_{21} ⌊$$

$${X}_{bias 3} = \frac{1}{2} ⌋ [ {X}_{2} + {X}_{bias 2} ] - [ {X}_{3} + {X}_{bias 3} ] - {X}_{32} ⌊ + ⌋ [ {X}_{1} + {X}_{bias 1} ] - [ {X}_{3} + {X}_{bias 3} ] - {X}_{31} ⌊$$

$${Y}_{bias 1} = \frac{1}{2} ⌋ [ {Y}_{2} + {Y}_{bias 2} ] - [ {Y}_{3} + {Y}_{bias 3} ] - {Y}_{32} ⌊ + ⌋ [ {Y}_{1} + {Y}_{bias 1} ] - [ {Y}_{3} + {Y}_{bias 3} ] - {Y}_{31} ⌊$$

$${Z}_{bias 3} = \frac{1}{2} ⌋ [ {Z}_{2} + {Z}_{bias 2} ] - [ {Z}_{3} + {Z}_{bias 3} ] - {Z}_{32} ⌊ + ⌋ [ {Z}_{1} + {X}_{bias 1} ] - [ {Z}_{3} + {X}_{bias 3} ] - {Z}_{31} ⌊$$

$${ϕ}_{bias 3} = \frac{1}{2} ⌋ [ {ϕ}_{2} + {ϕ}_{bias 2} ] - [ {ϕ}_{3} + {ϕ}_{bias 3} ] - {ϕ}_{32} ⌊ + ⌋ [ {ϕ}_{1} + {ϕ}_{bias 1} ] - [ {ϕ}_{3} + {ϕ}_{bias 3} ] - {ϕ}_{31} ⌊$$

$${θ}_{bias 3} = \frac{1}{2} ⌋ [ {θ}_{2} + {θ}_{bias 2} ] - [ {θ}_{3} + {θ}_{bias 3} ] - {θ}_{32} ⌊ + ⌋ [ {θ}_{1} + {θ}_{bias 1} ] - [ {θ}_{3} + {θ}_{bias 3} ] - {θ}_{31} ⌊$$

As is understood by those skilled in the art, these equations are just one example of estimate installation errors of fiducials 14 by comparing their poses to an expected installation. The calibration method 100 may cover more complex dynamics than those shown, such as taking into account the driven vehicle 12 pitching, rolling and changing heading. The calibration method 100 may be generalized to any number of fiducials 14 above three. The calibration method 100 may not be limited to using a Kalman filter. Other implementations may use a machine learning algorithm, convolution filters, line or shape fitting, or various other techniques.

The calibration method 100 may allow the user of the system 10 to simply set a guidance line near the fiducials 14 and drive with them in view. The output is a calibration that adjusts for installation mistakes.

The system 10 may have a number of safety systems, as described below.

In various implementations, the safety systems may include the use of multiple cameras.

In some implementations, fiducial 14 pose estimation may have a potential for errors. If a vehicle 12 bearing the camera is guided close to objects 16 marked out by the fiducial 14, the system 10 may need to be careful to not allow a poor pose estimation to cause a collision. The system 10 may use redundant cameras to detection outliers and errors. Any number of cameras may be used, such as the range of two cameras up to dozens of cameras.

In implementations where two cameras are used, the information from both cameras may be averaged or both poses may be input to a state estimator. The redundancy of the pose information may ensure that errors in one camera are able to be compensated for. In implementations of the system 10 using three or more cameras, this information redundancy may cause even more confidence in system 10 accuracy due to the likely agreement of the majority of camera data. In some implementations, the system 10 may choose a sub-group of cameras that agree most and averaging those most similar pose estimates, which may be valuable when some fiducials are only visible, or are best visible, from that sub-group.

In various implementations of the system 10, the safety system may include a safety proximity sensor.

Fiducials 14 and cameras have several advantages, such as a reasonable range, a lot of complex information, an entire pose, and the capability to distinguish specific objects 16. Other distance and position sensors may struggle to distinguish the target object 16 from other objects 16 in the environment, may suffer from poor range, or may be too expensive.

However, in various implementations, the system 10 may combine fiducials 14 with other sensors to ensure proper guidance and safe distance margins from the environment. In some implementation, the other sensor or sensors may be one or more radar, LiDAR, or laser range finders. The information of these radar, LiDAR, or laser range finder sensors, in various implementations, may not have their data used in guidance-generating systems unless they detect some other object 16 too close to the driven vehicle 12. In other implementations, the data from the other sensors may be used in the guidance-generating system.

In implementations where the other sensor data is only used to detect objects 16 that are too close, once any part of the environment crosses the safety threshold, the driven vehicle 12 may either stop or turn away from that object. The sensor design may be a single device pointing perpendicular to the camera bearing direction of travel of the driven vehicle 12. In one example, the camera bearing vehicle 12 may be a tractor pulling a grain cart 12 attempting to align with a semi pulling a grain trailer 16, in order to offload grain from the cart 12 to the trailer 16 using a distance sensor pointing to the left. In various implementations, and in this example, the auger of the grain cart 12 may extend to the left, so a collision on the left side of the grain cart 12 may be the only side of concern. Should the fiducial 14 pose estimates cause the tractor 12 to turn too close towards the grain trailer 16, the singular distance sensor may alarm the user, stop the tractor 12, automatically turn away from the grain trailer 16, or take various other actions that may be necessary or prudent.

In some implementations, a multi-point LiDAR may be the main guidance sensor and the fiducial 14 may only be a unique identifier 18 to distinguish the target object 16 from the environment. In such implementations, a multi-point LiDAR may return a large 3D point cloud. Because object recognition in LIDAR space may be difficult, may have questionable reliability, and may require significant processing power, design choices may be required to mitigate undesirable aspects of the technology. Two exemplary designs to combine this technology with fiducials 14 to mitigate or eliminate these problems are described below.

In the first example, a camera input may be combined with LiDAR. The camera may detect fiducials 14 that determine the angle and distance between the fiducial 14 and camera. In the event of a poor estimate of the fiducial 14 pose based on the camera data, it may be sufficient to set a zone of interest 20 on the LiDAR. In some implementations, it may be assumed that any returns within this zone of interest 20 are the desired object. The LiDAR may then estimate the pose of the object using the zone of interest 20 to filter its returns.

In the second example, the fiducials 14 may be visible by the LiDAR. Retro-reflectors or other super reflective items may be used to create a fiducial 14 identifiable in the LiDAR point cloud. In various implementations, the LiDAR identifiable fiducial 14 may be a flat plane, such as an AprilTag 14 made out of retro reflective tape or even IR LEDS, may be a three dimensional object with varying depth, or may be any other such object identifiable by LiDAR. In implementations using a three dimensional fiducial 14, the three dimensional nature of the fiducial 14 may assist in the estimate of the pose of the object 16 by comparing the parallax error of the two planes.

FIG. 5 shows a safety margin on the left side of a trailer 16 pulling a grain cart (red outline) as measured by a separate sensor. FIG. 6 shows an example of the safety zone of FIG. 5 being violated by the semi 16 and as such the tractor 12 turns away.

FIG. 7 shows an implementation of the system 10, where the fiducials 14 in the zone of interest 20 for a LIDAR.

In various implementations of the system 10, there may be constraints on the system 10 based on guidance, described in detail below.

In these implementations, the fiducial 14 may provide a position estimate of the parent object the fiducial 14 is mounted upon. As the driven vehicle 12 drives around the parent object 16, it may collect information about the location of the plurality of fiducials 14 captured by the cameras or sensors of the system 10. As described above, fiducials 14 may or may not have unique identifiers 18, which may identify the type of parent object 16 on which they are mounted, such as static or mobile. In some implementations, the camera bearing tractor 12 may form and use a database of fixed locations, previous locations of fiducials 14 that move, and fiducials 14 actively in view to safely guide about the space.

For example, during harvest it may be the case there are two or more semi-truck grain trailer units 16 in the field at the same time. It is possible for the trucks and trailers 12 to park such that the necessary guidance alongside one trailer 12 may cause a collision with the second, which is diagrammed in FIG. 8. The camera system may recognize the fiducial 14 in view is in fact a different trailer 12 and may estimate pose of the camera bearing vehicle 12 to be at risk of a collision.

Once a potential collision is detected the user may be warned, the vehicle 12 may be stopped, the vehicle 12 may be guided around the danger, or various other actions that may be necessary or prudent may be taken. FIG. 8 shows this potential collision of the vehicle 12 with a secondary grain trailer 12, which can be noted by the path 22 of the vehicle 12 intersecting the secondary grain trailer 12. In situations such as this, the system 10 may redirect the path 22 or may stop the vehicle 12 to ensure a collision is avoided.

Various implementations of the system 10 may use error reduction techniques to improve accuracy of measurements of visual fiducials 14.

In some implementations, the error reduction technique may involve the elimination of impossible scenarios and may involve analyzing the quality of harsh-angle views.

In these implementations, the system 10 may consider if the pose estimate of the fiducial 14 is physically possible. The system 10 may also generate a quality of view estimate which reduces as the view of the fiducial 14 becomes more limited or at harsher angles in order to filter out or reject potentially bad results.

Turning now to FIG. 9, the following exemplary algorithm calculates a value Γ in various circumstances where the fiducial 14 may be to the left or right of the camera and may be angled towards the camera or angled away, the angles upon which the value Γ is based may be measured relative to the center of the field of view of the camera. As would be understood, variations on this algorithm or other algorithms may be used. This specific algorithm is merely exemplary and is not an exclusive method of reducing error within the system 10.

A negative value for I may indicate an impossible scenario where the fiducial 14 would not be physically visible and therefore the estimate must be inaccurate. In instances of negative Γ values, the system 10 may exempt those values from estimation calculations. The fiducial 14 may tend to be closer to perpendicular with the center of the field of view of the camera as Γ approaches π radians. For example, if the fiducial 14 is to the left of the camera and facing away from the camera, Γ would be negative. Since we cannot see the fiducial 14 from the backside, this estimate may be rejected. Further, a threshold may be chosen such that fiducials 14 which are barely visible are rejected under the assumption the estimate will be poor, as distortions may occur due to relying on the extreme edges of the camera lens. FIG. 9 shows two possible scenarios showing how I varies.

$${X}_{f} = Horizontal offset of fiducial from camera in camera space$$

$${Y}_{f} = Vertical offset of fiducial from camera in camera space$$

$${Z}_{f} = Forward offset of fiducial from camera in camera space$$

$${ϕ}_{f} = Roll of fiducial in camera space$$

$${θ}_{f} = Pitch of fiducial in camera space$$

$${ψ}_{f} = Yaw of fiducial in camera space from 0 to 2 π$$

$$Γ = Quality of fiducial view parameter .$$

$$⊤ = arctan ( {Y}_{f} / {X}_{f} )$$

$$Γ = \{ \begin{matrix}1 , & if {ψ}_{f} = 0 \\ ∞ , & if {ψ}_{f} = π \\ ∞ , & if {ψ}_{f} > π and τ = 0 \\ \frac{π}{2} + τ - {ψ}_{f} , & if {ψ}_{f} < π and τ > 0 \\ - τ + {ψ}_{f} - \frac{3}{2} * π , & if {ψ}_{f} > π and τ > 0 \\ - \frac{3}{2} π + τ + {ψ}_{f} , & if {ψ}_{f} > π and τ < 0 \\ \frac{π}{2} - τ - {ψ}_{f} , & if {ψ}_{f} < π and τ <= 0\end{matrix}$$

Various implementations of the system 10 may improve pose estimates using a purposeful skew.

In various implementations, visual fiducials 14 may rely on shape matching to estimate pose. For example, AprilTags 14 rely on identifying the square shape of the tag. The total size and the skew of the found square may be used to calculate the pose of the AprilTags 14. The pose estimate, specifically the roll, pitch and yaw estimate may be error prone when the fiducial 14 is pointing directly at the camera. Without being bound by theory, this may be because the observed square does not change much with small changes in pitch and yaw when the pitch and yaw values are less than five degrees off of center. To better visualize this effect, small angle approximations may be considered. One small angle approximation is sin θ=θ. The impact of angle changes near zero is small and thus the impact of the observed square is small. This may lead to minor pixel changes causing significant pose estimation changes. This technique may remove this inaccurate zone by mounting the fiducials such that, during normal operation, the fiducials 14 are never pointed directly at the camera. This may be seen in FIG. 10, where the fiducial 14 is mounted in a non-flush position relative to the surface of the target vehicle 16 on which it is mounted. There are various combinations of pitch and heading changes that may achieve this. The technique may reduce the total angles from which the fiducial can be seen as a tradeoff for pose estimation accuracy. Below are a few examples, but this technique is not limited to those enumerated.

If the fiducial 14 is at the same height as the camera or below it, it may be mounted with purposeful pitch towards the ground.

If the fiducial 14 is at the same height as the camera or above it, it may be mounted with purposeful pitch towards the sky.

If the desire is to always stay to the right of the fiducial 14, it may be mounted with a purposeful yaw facing left.

If the desire is to always stay to the left of the fiducial, it may be mounted with a purposeful yaw facing right.

FIG. 10 shows an AprilTag 14 pointed away from parallel to a trailer 16 to increase the visual skew.

Various implementations of the system 10 may improve range estimates by reducing skew.

Some fiducial 14 installation locations may require the fiducial 14 to face perpendicular to the camera. This installation situation may result in the fiducial 14 only being visible if the camera is offset substantially from the fiducial 14 or very close to it. For example, an AprilTag 14 may be mounted on a straight long object 16 where it is desired to drive alongside in parallel. The natural fiducial 14 install for this example may be to place them flat along the object 16. However, if the camera is very close to the object 16, the camera may not see enough of the AprilTag 14 to identify it or estimate its pose.

This technique may involve the installation the fiducial 14 on a wedge 24 so the portion closest to the object 16 is touching or about touching the long straight object 16 but the end of the fiducial 14 furthest from the object 16 is offset from the object 16. The result is a fiducial 14 that sticks out from the object 16 slightly. By turning the fiducial 14 towards the camera, its pose may be estimated from more locations.

FIG. 11 shows an exemplary AprilTag 14 installed to reduce the visible skew when driving parallel to a trailer.

To ensure this technique assists with visibility in more than one direction of travel, this fiducial 14 raising technique may use a mirror image of the fiducial 14 on the other side of the wedge.

Various implementations of the system 10 may improve accuracy by removing erroneous pose estimations with known pitch and/or roll.

Due to camera and lighting inconsistencies, the pose estimates from a visual fiducial 14 may be inaccurate. One form of inaccuracy is a sudden and significant deviation in the roll, pitch, and yaw all together. The incorrect estimation may resolve itself shortly after. The following technique provides an effective check for pose estimations allowing poor estimations to be ignored.

The fiducial 14 may be mounted with a purposeful pitch, roll, or pitch and roll beyond zero degrees. This pitch and/or roll may be known to be constant for the given use case. It may be either constant because the operation space is flat or because the roll, pitch, and yaw of the camera is known and allows us to estimate the gravity stabilized roll, pitch, and yaw of the fiducial.

The estimate of the fiducial 14 may be the X, Y, Z, roll, pitch and yaw of the fiducial 14 relative to the camera or gravity. If the estimate from the roll and/or pitch does not match known installation values, the system 10 may presume that the rest of the values are incorrect as well. This technique may reject any estimations that do not match known, fixed parameters. Note, roll and pitch may not be the only possible values to limit. If the distance is unchanging, then an expected distance could be rejected. If the use case has dynamic roll and pitch but a fixed yaw, then yaw may be rejected.

Various implementations of the system 10 may improve accuracy by using two visible mirrored fiducials 14.

The pose estimate of visual fiducials 14 and their reliability may be improved by placing two fiducials 14 in view that share some values but have known offsets of other values.

For example, two AprilTag 14s may be mounted touching one another and near the height of the camera. The top AprilTag 14 may have an about 30 degree pitch towards the sky. The bottom AprilTag 14 may have an about 30 degree pitch towards the ground. This configuration is shown in FIG. 12. Because the AprilTags 14 may be close to the same height as the camera, both may be seen at the same time.

In implementations where both fiducials 14/AprilTags 14 are in view, the quality of the pose estimate of both tags may be analyzed by comparing their pitch difference with the known installation pitch difference. In instances where the pitch differences fall within a threshold, all of the pose values may be averaged to find a more stable pose equivalent, as if there was a single flat tag mounted instead.

As before, this is not limited to pitch. Distances, yaw, roll or any known fixed combination of those would work as well.

This installation technique may also reduce the changes that no fiducial 14 is visible because of the possibility that one fiducial 14 may remain visible when others may be obstructed from view.

Various implementations of the system 10 may improve accuracy by estimating an object with a plurality of fiducials 14.

In some implementations, it may be desired to find the pose of an object 16 that is large enough to fit multiple fiducials 14. In such implementations, the estimated pose of that object 16 may be improved by using multiple fiducials 14 if all the fiducials 14 have a known installation offset pose relative to the object 16.

If multiple fiducials 14 are in view at the same time, the system 10 may use the installation offset pose of each fiducial 14 to individually estimate the pose of the target object 16. After doing so with each visible fiducial 14, there may be a list of estimates of the pose of the target object 16. An average of these estimates may improve the final estimate of the pose of the target object 16. This technique is not limited to a simply average, but may be used with any filtering strategy combining multiple fiducial 14 poses.

Even if multiple fiducials 14 are not visible at the same time, the technique may be conducted on historical fiducial 14 positions. If the pose of the camera is known in some higher reference frame, such as GPS coordinates, the pose of the fiducials 14 may be translated into poses in the higher reference frame. Those poses may be stored and used to estimate the position of the object more accurately, over time. For example, AprilTags 14 may be installed along a wall in a particular implementations. A vehicle 12 with a camera, IMU, and GPS system may drive alongside that wall. Each AprilTag 14 pose may be converted into a GPS coordinate position, roll, pitch, and heading. The estimated position of the wall may be improved over time by finding a best fit line for the historical poses. This technique is not limited to line fitting nor the higher reference frame being GPS.

Various implementations of the system 10 may improve accuracy using various other sensors combined with visual fiducials 14.

Multiple other sensors may be combined with visual fiducials 14 to improve our estimate of the pose of the target object 16. These other sensors include but are not limited to LiDAR, GPS sensors, radar, a laser range finder, ultrasonic sensors, and combinations thereof.

In various implementations, the camera may find the position of the visual fiducial 14 and may share that location with a LiDAR mounted near to camera. The LiDAR may be able to trust that position is part of the target object 16 and filter the LiDAR returns for a better distance measurement or pose estimate than can be obtained from the camera alone.

The system 10 may use the estimate from the camera of the pose of the target object 16 to guide towards that object 16, but the system 10 may switch to more accurate sensors when getting close to the object 16. The more accurate sensor may be radar, a laser range finder, ultrasonic or many other sensors and combinations thereof.

In various implementations, an inaccurate GPS position of the target object 16 may be used to guide towards the object 16 from further than the camera can see the visual fiducial 14. Once close enough, the more accurate pose estimation from the camera may be used for accurate guidance to the object 16.

Various implementations of the system 10 may improve accuracy by filtering visual fiducial 14 pose estimates with camera movements.

Various techniques for estimation and sensor fusion may be used to combine sensors to better estimate a value. If the pose of the camera is known in a higher reference frame, such as GPS coordinates, the movement of the camera may be used to filter the fiducial pose estimates.

As an example, a Kalman filter can be used to compare the rate of heading change from the pose of the camera to the fiducial 14 yaw estimate in camera space. The rate of change of heading and fiducial 14 yaw may likely be the same. Fiducial 14 pose estimates that do not match may be filtered or rejected. This technique is not limited to comparing heading and yaw, but instead may be used for a variety of estimated and measured values.

Various implementations of the system 10 may improve camera and camera pose synchronization.

In various implementations, there be difficulty in combining the data of the camera observing visual fiducials 14 with the data of other sensors that may be responsible for tracking the pose of camera in a higher reference frame. This difficulty may be caused by insufficient processing time. In some implementations, the camera processing time may be significant and may cause phase delay between the different sensors.

For example, a camera estimating the pose of an AprilTag 14 or other fiducial 14 may take as long as a second of processing time per image taken by the camera. Of course, in other implementations more time or less time may be required. If the higher reference frame pose of the camera is tracked by a GPS running at, for example, 10 hz, by the time the pose of the fiducial 14 is calculated, the GPS may have moved about ten times. The resulting higher reference frame estimate of the pose of the fiducial 14 may be incorrect because it may match a newer GPS position to an older image.

This issue may be fixed by time stamping the images and keeping a history of higher reference frame camera poses. Then, upon finishing the processing, the system 10 may find the appropriate time-matched higher reference camera pose for the new image.

In other implementations, an alternative technique may be used. This alternative technique may eliminate the need to maintain a shared time between two devices. In this technique, when the camera takes a new image but has not yet processed the image, the camera may send a message to the higher reference frame device. The higher reference frame device may store its current camera pose estimate. The camera may then complete the image processing and may send a visual fiducial 14 pose to be matched with the camera pose. The higher reference frame device may load its singular saved camera pose and may match it with the newest image. This technique may more dynamically align the pose of the camera with the pose of the visual fiducial 14.

Various implementations of the system 10 may use techniques to improve user experience in the use of guidance from visual fiducials 14.

Some implementations may improve the user experience by informing the user when guidance using visual fiducials 14 is ready to engage. In implementations with a hectic agriculture environment, the user of the system 10 may not always be able to keep watch on their guidance system. The system 10 may automatically inform the user when the visual fiducials 14 are in view and have given a sufficient pose estimate of the target object 16. The automatic notification may include but are not limited to audible beeps, physical vibrations, and visual indications.

Various implementations of the system 10 may use techniques to improve user experience by automatically guiding vehicles 12 toward visual fiducials 14.

In various applications of the system 10, the user may be manually steering the driven vehicle 12. It may be desirable for the system 10 to automatically begin guidance of the driven vehicle 16 once fiducials 14 become visible to the system, allowing the user to turn their attention to other controls. In implementations of the system 10 with this functionality, the system 10 may automatically switch to guiding based on the visual fiducial 14 after a warning period that allows the user to refuse the switch over. Upon first obtaining a sufficient pose estimation for the visual fiducial 14, the user may be notified the system 10 is about to switch control. This notification may be delivered through a variety of means, such as but not limited to audible or visual cues. The user may be offered a time window to reject the switch. If the user does not reject the switch, the system may automatically begin to guide the vehicle based on the visual fiducial 14.

FIG. 13 shows an example of an implementation where a grain cart 12 is unloading into a grain trailer semi-truck combination 16. In this implementation, the grain cart 12 may be guided by the system 10 automatically towards the grain trailer 16 and automatically switch to guiding based on the visual fiducials 14 as the grain cart 12 closes the distance to the grain trailer 16.

Various implementations of the system 10 may use techniques to improve user experience by automatically ceasing visual fiducial guidance.

In various implementations, the system 10 may use visual fiducials 14 to help guide a driven vehicle 12 to a location to conduct a task. When that task is complete, the user of the system 10 may have another task to conduct that may require the attention of the user. For example, after offloading a grain cart 12 load of harvested product into a grain trailer 16, the grain cart 12 may need to drive up alongside a combine 16 to take on a new load of product. It may be important for the user of the system 10 to be able to easily switch to their new task. The system 10 provides a way to detect if the user is complete with the task related to the visual fiducial 14 and ready to move onto the next.

In these implementations, if data relating to a visual fiducial 14 is recorded in a higher reference frame, such as GPS, the system 10 may calculate the distance and heading offset the vehicle 12 has traveled since the fiducial 14 was last seen by the camera or other sensor. The system 10 may look to various parameters to determine an appropriate time to disengage the automatic guidance based on visual fiducials 14. In various implementations, these parameters may be distance between the driven vehicle 12 and target vehicle 16, differences in heading between the driven vehicle 12 and target vehicle 16, the visibility of fiducials 14 to the camera or other sensors, timers related to parameters, and various other considerations. FIG. 14 shows an implementation of the system 10 where the driven vehicle 12 and target vehicle 16 are reaching a sufficient distance and heading that the system 10 may disengage the automatic guidance based on visual fiducials 14. FIG. 15 shows an implementation of the system 10 where the heading of the driven vehicle 12 and target vehicle 16 is sufficiently different for the system 10 to disengage the automatic guidance based on visual fiducials 14. Various thresholds may be used to determine when guidance may be disengaged, such as but not limited to when the driven vehicle 12 and target vehicle 16 are about 200 feet away from one another or when the heading of the driven vehicle 12 and target vehicle 16 exceeds about 30 degrees.

Various implementations of the system 10 may use techniques to improve user experience by using pre-programmed and dynamically edited offsets from the visual fiducials 14.

In various implementations, the visual fiducial 14 may be mounted onto an object that may be best approached through an indirect route. For example, a portion of a grain silo 16 or grain trailer 16 may be physically struck by the driven vehicle 12 if approached directly due portions of the target object 16, such as the grain silo 16 or grain trailer 16, extending from the fiducial 14 mounting area.

The system 10 may account for these scenarios by having each fiducial 14 be associated with pre-programming or calibration of the system 10 so that the system 10 may know where the fiducial 12 is located on the target object 16. To generate useful guidance, each visual fiducial 14 or group of fiducials 14 may have a user programmable distance and angle offset to use as the target for guidance.

In various implementations, the distance and angle offset may be edited dynamically while the driven vehicles 12 are being actively guided by the system 10. This may be done by entering new numerical offsets or with user controls that make small changes with each press. These adjustments may allow the users of the system 10 to adjust the offsets based on visual line up or to better align operating parts of the vehicle with their target objects 16.

As shown by the example in FIG. 16, when a grain cart 12 is guiding alongside a grain trailer 16, the grain cart 12 may need to steer parallel to the trailer 16 at a specific horizontal offset, such as but not limited to about twelve feet, to ensure the output spout of the grain cart 12 is placed over the center of the opening of the grain trailer 16.

Various implementations of the system 10 may use techniques to improve user experience by using complex guidance to visual fiducials 14.

In various implementations, it may not be desirable for a driven vehicle 12 to navigate directly to an observed fiducial 14 or for the driven vehicle 12 to use an offset path and heading as described above. The system 10 may instead steer to avoid visual fiducials 14 or visually identified obstacles, steer with a larger offset at a longer distance to the fiducial 14 and decrease the offset as the fiducial 14 becomes closer, giving a more accurate distance estimate, steer towards another unseen visual fiducial 14 with a known offset from the current observed fiducial 14. The system may have a master safety that overrides all other control methods if the driven vehicle 12 navigates too close to a visual fiducial 14 or to some area described by one or more fiducials 14.

Various implementations of the system 10 may use techniques to improve user experience by adjusting guidance for roll, pitch, and height differences.

In various implementations, the visual fiducials 14 may be mounted on a target vehicle 16 or structure that may have a different roll and/or pitch or be at a height difference from the driven vehicle 12. In some instances, portions of the driven vehicle 12 may need to be carefully placed in reference to the parent object/vehicle 16 of the fiducial 14. A single consistent horizontal offset may be sufficient if both the driven vehicle 12 and parent object 16 are on flat ground. However, any combination of roll, pitch, or height difference may cause collisions or undesirable placement.

For example, a grain cart 12 steering alongside a grain trailer 16 may attempt to put its spout directly over the center of the trailer 16. If the grain cart 12 is higher than the trailer 16, the desired offset may be the same as if both were on the same flat ground. However, if the trailer 16 were higher than the grain cart 12, the grain cart 12 may need a bigger horizontal offset to ensure the grain cart 12 auger does not strike part of the semi or grain trailer 16. A larger horizontal offset may cause the grain cart 12 spout to be off center from the grain trailer 16, but this may be acceptable compared to a physical collision. In some implementations, the spout may be adjustable to handle this offset. Similarly, if the grain cart 12 is rolled towards the grain trailer 16, the grain cart 12 auger may strike the other vehicle 16. If the grain cart 12 is rolled away, the grain cart 12 may need to drive closer to the trailer to center the spout. Because the pitch of a target vehicle 16 may be less likely to cause a collision, it may be sufficient to simply warn the user about the potential collision caused by variation in pitch.

This technique may use the pose estimate of the visual fiducial 14 to calculate the roll, pitch, and height differences between the driven vehicle 12 bearing the camera and the target object 16 of the fiducial 14. It may then adjust the guidance path 22 to avoid collisions and ensure the driven vehicle 12 is placed in an appropriate location. These adjustments may include, but are not limited to, a greater offset from the fiducial 14, a different heading offset from the fiducial 14 and/or adjusting other actuators on the driven vehicle 12 or target object 16. If no adjustment is able to be made, a warning may be sent to the user of the system 10 that a collision or other issue may occur.

Although the disclosure has been described with references to various implementations, persons skilled in the art will recognize that changes may be made in form and detail without departing from the spirit and scope of this disclosure.

What is claimed is:

1. An agricultural guidance system comprising:
(a) one or more visual fiducials on a first object;
(b) at least one camera mounted to a first vehicle,
wherein the at least one camera views of the one or more visual fiducials and generates guidance and operations therefrom.

2. The agricultural guidance system of claim 1, further comprising one or more sensors configured to improve the accuracy of guidance and operations.

3. The agricultural guidance system of claim 2, wherein the one or more sensors are selected from the group consisting of LiDAR sensors, GPS sensors, radar, laser range finders, and ultrasonic sensors.

4. The agricultural guidance system of claim 1, wherein the system generates guidance and operations by calculating a quality of fiducial view parameter associated with each fiducial of the one or more visual fiducials.

5. The agricultural guidance system of claim 4, wherein the quality of fiducial view parameter is determined based on an angle between a center of a field of view of the at least one camera and the one or more visual fiducials and based on the pose of one or more visual fiducials relative to the at least one camera.

6. The agricultural guidance system of claim 5, wherein some of the one or more visual fiducials are not used in the generation of guidance and operations if the corresponding quality of fiducial view parameter is negative.

7. The agricultural guidance system of claim 1, wherein the first object is mobile.

8. The agricultural guidance system of claim 1, wherein the first object is stationary.

9. An agricultural guidance system comprising:
(a) one or more fiducials on a first object;
(b) a camera mounted to a driven vehicle,
wherein the camera views the one or more fiducials and generates a path on which the driven vehicle may navigate.

10. The agricultural guidance system of claim 9, wherein the camera is configured to record images of a pose of the one or more fiducials, each image of the images taken at a recorded time.

11. The agricultural guidance system of claim 10, further comprising a GPS sensor on the driven vehicle, the GPS configured determine location coordinates of the driven vehicle at the recorded time.

12. The agricultural guidance system of claim 11, wherein the images taken at a recorded time and the location coordinates of the driven vehicle at the recorded time are combined to create a higher reference frame pose of the one or more fiducials.

13. The agricultural guidance system of claim 12, wherein the higher reference frame pose of the one or more fiducials is used to ensure accuracy of the path.

14. The agricultural guidance system of claim 9, wherein each of the one or more fiducials comprises a unique identifier.

15. The agricultural guidance system of claim 14, wherein the path may be modified to avoid collisions between the driven vehicle and portions of the first object extending from a fiducial mounting area.

16. The agricultural guidance system of claim 15, wherein the portions of the first object extending from a fiducial mounting area are identifiable by the unique identifier.

17. An agricultural guidance system comprising:
(a) a visual fiducial on a first object;
(b) a camera mounted to a driven vehicle,
wherein the camera views the one or more fiducials.

18. The agricultural guidance system of claim 17, wherein the visual fiducial is mounted to the first object with a purposeful skew to allow for improved detection of changes in roll, pitch, and heading of the visual fiducial.

19. The agricultural guidance system of claim 17, wherein the visual fiducial is mounted to the first object with a wedge to improve detection of the visual fiducial by the camera when the camera is near the first object.

20. The agricultural guidance system of claim 17, comprising a second visual fiducial, wherein the visual fiducial is mounted to the first object with a skew in a first direction, and the second visual fiducial is mounted to the first object with a skew in a second direction, the second direction being approximately the opposite of the first direction.
